(19) United States
(12) Patent Application Publication
(10) Pub. No.: US 2003/0084305 A1
(43) Pub. Date: May 1, 2003

(54) System and method to generate an output including a machine readable code representation of biometric information

(76) Inventors: William G. Siegel, Wellington, FL (US); Greg L. Cannon, Boynton Beach, FL (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/255,113

(22) Filed: Sep. 26, 2002

Related U.S. Application Data
(60) Provisional application No. 60/324,517, filed on Sep. 26, 2001.

(51) Int. Cl. H04L 9/32

(52) U.S. Cl. 713/186; 382/115; 713/202; 340/5.82; 340/5.52

(57) ABSTRACT

A system and method generates an output that includes a machine readable code representation of biometric information from an individual. The output can be placed on an object(s) associated with the individual. This may allow tracking through a facility of both the individual and the object associated with the individual.

### CROSS-REFERENCE TO RELATED APPLICATIONS

This application claims priority under 35 U.S.C. §119(e) to U.S. Prov.

App. No. 60/324,517 filed Sep. 26, 2001, which is incorporated by reference herein in its entirety.

The application is related to U.S. Appl. No. 10/ - - - , - - - , entitled “Biometric Based Facility Security” (Atty. Docket No. 1823.0480001), filed concurrently, which is incorporated by reference herein in its entirety.

### BACKGROUND OF THE INVENTION

1. Field of the Invention

The present invention is related to biometrics, and in particular to an output that includes a machine readable code representation of biometric data.

2. Background Art

Access control systems are used to limit access to selected individuals. Some of these systems use biometric technologies to determine whether access for an individual will be granted or denied. A biometric is a unique, measurable characteristic or trait of a human being for automatically recognizing or verifying identity. For instance, fingerprint biometrics are largely regarded as an accurate method of biometric identification and verification. See, e.g., Roethenbaugh, G. Ed., Biometrics Explained (International Computer Security Association: Carlisle, Pa. 1998), pages 1-34, which is herein incorporated by reference in its entirety. Access control units (ACUs) may be placed locally or remotely to perform a biometric analysis on the individual, and determine whether access will be granted or denied.

Biometric information has been used to identify individuals, but has not been associated with an individual's belongings or personal property. Thus, efforts to improve security at facilities with biometric detection are limited with respect to belongings or other articles transported or carried by individuals through the facility.

### BRIEF SUMMARY OF THE INVENTION

The present invention provides a system and method for instantly generating an output that includes a machine readable code representation of biometric information from an individual, where the output can be placed on an object(s) associated with the individual. This allows tracking through a facility of both the individual and the object associated with the individual. Such tracking is highly secure as it is linked to biometric information.

In aspects of the present invention, a system is provided that includes a biometric capture device that captures biometric information of an individual checking in at a facility. The system also includes a processor that processes the biometric information captured by the biometric capture device to generate a processed biometric signal. The system further includes an output device that receives the processed biometric signal from the processor and that generates a self-adhering output based on the signal. The output includes a machine readable code representation of the processed biometric information. The output is associated with an object of the individual.

Further aspects of the present invention provide a method including the step of capturing biometric information from an individual. The method also includes the step of processing the biometric information to generate a processed biometric signal. The method further includes the step of generating machine-readable code on a self-adhering output based on the processed biometric signal. The machine-readable code is representative of the captured biometric information.

Further aspects, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an example system for generating an output including machine-readable code representative of biometric information according to embodiments of the present invention.

FIG. 2 shows an exploded view of an example output of the system shown in FIG. 1.

FIGS. 3A-3P show examples of machine-readable code that can be printed on or affixed to the output in FIGS. 1 and 2.

FIG. 4 is an example of machine-readable code representing biometric data.

FIG. 5 shows an example flow chart depicting a method for generating an output that includes a machine readable code representation of biometric information according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Overview

Embodiments of the present invention provide a system and method for instantly generating an output that includes a machine readable code representation of biometric information from an individual, where the output can be placed on an object(s) associated with the individual. This may allow tracking through a facility of both the individual and the object associated with the individual. The output can be coupled to an object, for example, an entry pass, a ticket, a voucher, an ID badge, a bag, luggage, or baggage, or the like.

The use of the term “biometric data” or “biometric information” throughout the specification can be representative of a biometric, a digital or other image of a biometric (e.g., a bitmap or other file), extracted digital or other information relating to the biometric (e.g., minutia of a fingerprint), etc. A biometric as used throughout the specification may be a physical part of an individual, such as an eye, a finger, a limb, etc. An accessed system as used through the specification may be any known system that requires some limitation to entry, which can be an airport, a bus station, a mall, a school, a computer, electrical or mechanical equipment, a room, a hallway, a building, a section of a compound, etc. Matching used throughout the specification relates to matching either 1:1 to determine if the individual matches with whom he/she says he/she is, or 1:m, where m=all the enrollees, to determine if an individual is an enrollee at all.

System

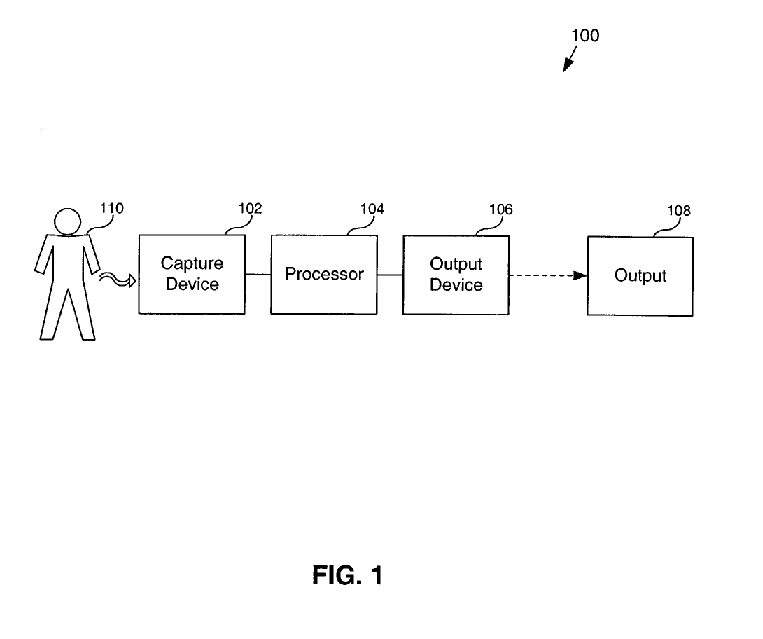

FIG. 1 shows a system 100 use to generate an output including machine readable code representative of biometric information of an individual according to embodiments of the present invention. System 100 includes a capture device 102, a processor 104, and an output device 106 that generates an output 108. Capture device 102 can be any device available (e.g., a fingerprint scanner, a camera, or other biometric capture device) for capturing any biometric of an individual 110, for example a fingerprint, a facial scan, a retinal scan, or the like.

The captured biometric information is then processed in processor 104. In some embodiments, processor 104 can generate a processed biometric information signal based on the captured biometric information. Processor 104 may be any type of processing device, including a processor located in a computer system, workstation, handheld device, and other systems. For example, an image of a fingerprint can be captured and stored as grayscale data. This print can be drawn from all or part of one or more fingers, a palm, a hand, or a foot. The grayscale data is then included in the processed biometric information signals. In other embodiments, processor 104 can extract biometric data from the biometric information and generate a processed biometric information signal based on the extracted biometric data. In the example of fingerprint capture, grayscale data can be further processed to extract minutia information. This minutia information is then included in the processed biometric information signal. In still other embodiments, other forms of biometrics can be the basis for the processed biometric information signal.

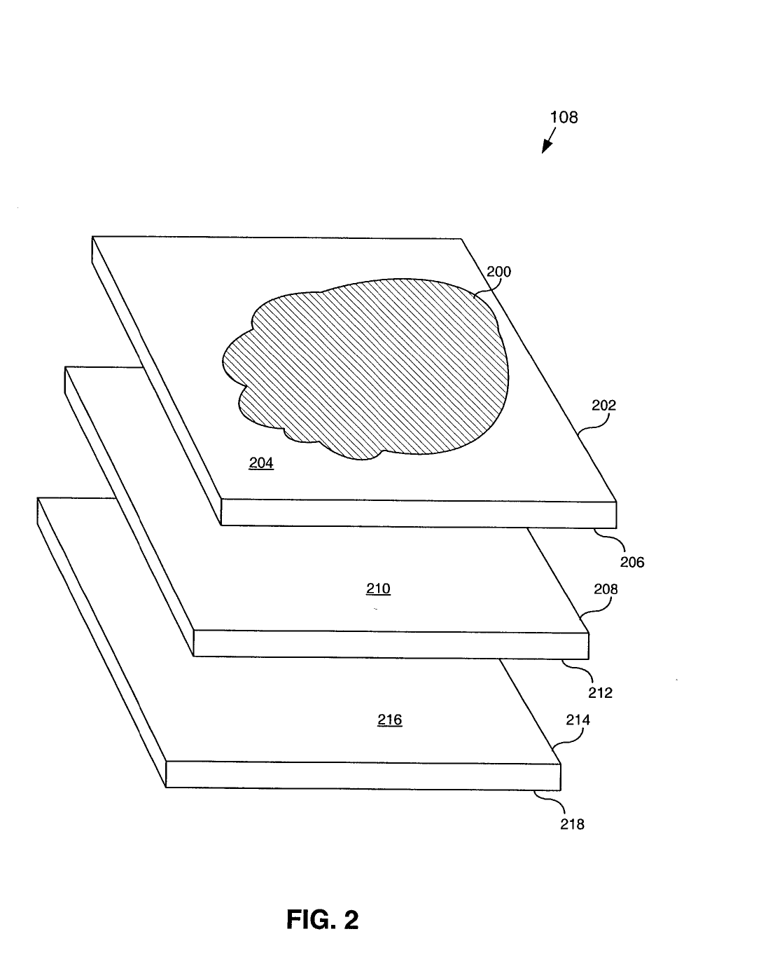

Output device 106 receives the processed biometric information signal and uses it to generate output 108. For example, output device 106 may be a printer or any other type of output device. Output 108 includes a machine readable code representation 200 (FIG. 2) of the captured biometric information, extracted biometric data, or the like, described in more detail below.

FIG. 2 shows an exploded perspective view of output 108, according to embodiments of the present invention. For example, output 108 could be a sticker or tag, an entry pass, a ticket, a voucher, an ID badge, a bag, luggage, or baggage. For example, output 108 can be a label having a self adhering surface with machine readable code printed or affixed thereon.

In the example shown in FIG. 2, output 108 includes a first section 202, which has a first surface 204 including machine readable code 200 thereon, and a second surface 206, which is opposed to first surface 204. Coupled to first section 202 is second section 208, which is shown as being a same size as first section 202, although it can be larger or smaller as desired. Second section 208 is a self adhering section that includes a first surface 210 coupled to second surface 206 and a second surface 212 that is self-adhering, and is opposed to first surface 210. A third section 214 is coupled to second section 208, shown as being the same size as first section 202 and second section 208 in FIG. 2, but can be sized to appropriately cover an adhering area of self-adhering surface 212. Third section 214 is a removable device (e.g., a peal away waxy device) that is temporarily secured to the self-adhering surface 212, and is removed when output 108 is to be adhered to another object. Third section 214 includes a first surface 216 that is removably coupled to self adhering surface 212, and a second surface 218, which is opposed to first surface 216.

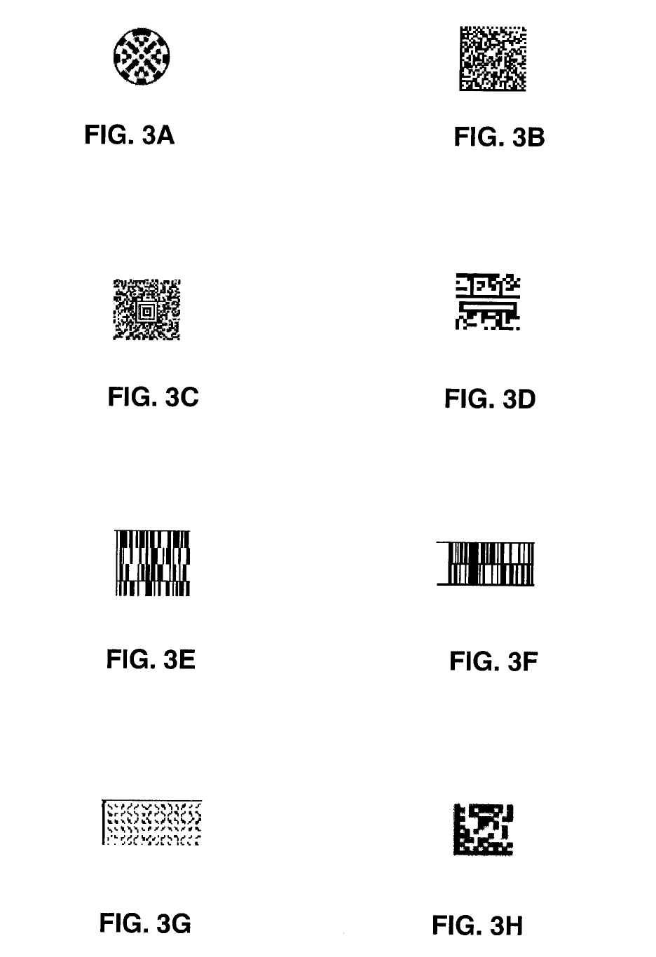

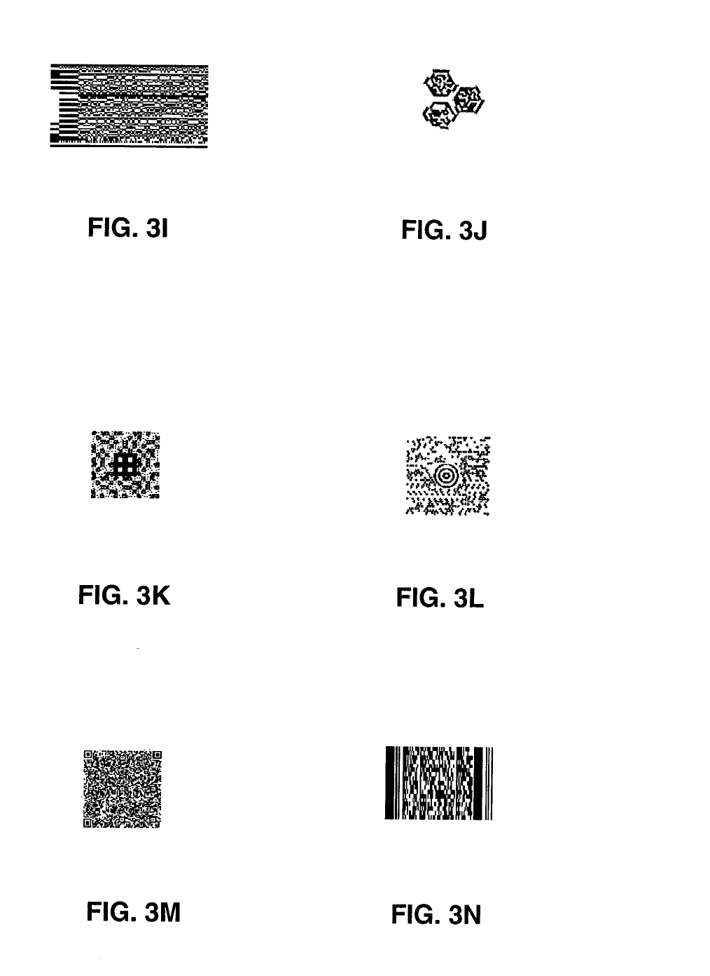

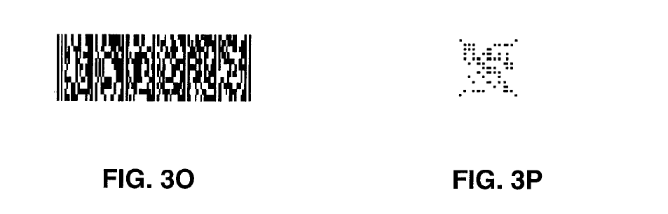

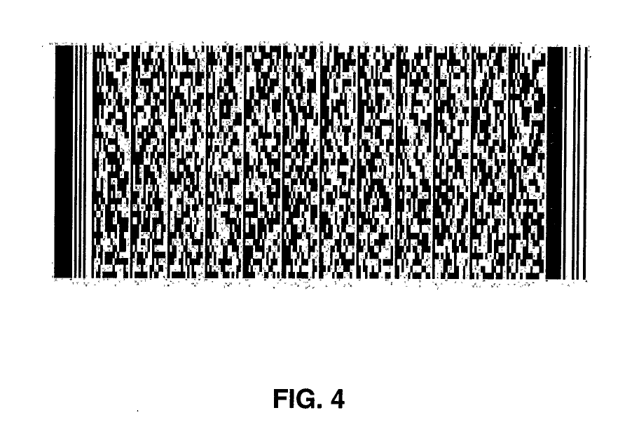

FIGS. 3A-3P show various examples of machine-readable code 200 according to various embodiments of the present invention. Trademark and Copyright laws may apply to some of these machine readable code examples. FIG. 3A is an example of 3-DI developed by Lynn Ltd. of Ann Arbor, Mich. FIG. 3B is an example of Data Matrix developed by Acuity CiMatrix. FIG. 3C is an example of Aztec Code developed by Welch Allyn Inc. FIG. 3D is an example of Code 1 developed by Ted Williams. FIG. 3E is an example of Code 49 developed by Intermec Corporation. FIG. 3F is an example of Code 16K developed by Ted Williams. FIG. 3G is an example of DataGlyphs developed by Xerox PARC. FIG. 3H is an example of CP Code developed by CP Tron, Inc. of El Cerrito, Calif. FIG. 31 is an example of Datastrip Code (originally called Softstrip) developed by Softstrip Systems, now owned by Datastrip Inc. FIG. 3J is an example of ArrayTag invented by Dr. Warren D. Little. of the University of Victoria. FIG. 3K is an example of MiniCode developed by Omniplanar, Inc. FIG. 3L is an example of MaxiCode (originally called UPSCode) developed by the United Parcel Service. FIG. 3M is an example of QR Code (Quick Response Code) a matrix code developed by Nippondenso ID Systems. FIG. 3N is an example of PDF (Portable Data File) 417 that was developed by Symbol Technologies. FIG. 30 is an example of SuperCode invented by Ynjiun Wang. FIG. 3P is an example of Snowflake Code developed by Electronic Automation Ltd. Although appearing exhaustive, additional machine-readable codes exist that can be utilized by the invention. It is to be appreciated other known and not yet developed machine-readable codes can also be used without departing from the scope of the invention.

FIG. 4 is machine readable code representation of biometric data (e.g., a fingerprint) according to an embodiment of the present invention.

Many of the machine-readable codes shown above are either two dimensional (2D) or three-dimensional (3D) codes. Other names for these codes are Matrix code, stacked symbology, or multi-row codes. 2D codes can be made up of a series of one-dimensional bars. Two-dimensional barcodes may store information along a height and length of the symbol. Presently, there are about twenty 2D barcodes. Some 3D barcodes may be considered to be a linear (1D) barcode that is embossed on a surface. The 3D code is read using differences in height, rather than contrast, to distinguish between bars and spaces. This type of code can be used where printed labels will not adhere, and be permanently affixed to an object. Both types of barcodes allow for an increased amount of data or information to be stored in a smaller space than 1D barcodes. In essence, a multitude of 1D codes can be reduced to one 2D or 3D code that includes more information than the sum of the 1D codes. In many instances, the 2D and 3D codes can be more accurately generated and scanned. Further, these codes can be encrypted using known encryption techniques and/or digitally signed using known digital signing techniques to provide another layer of security.

Methodology

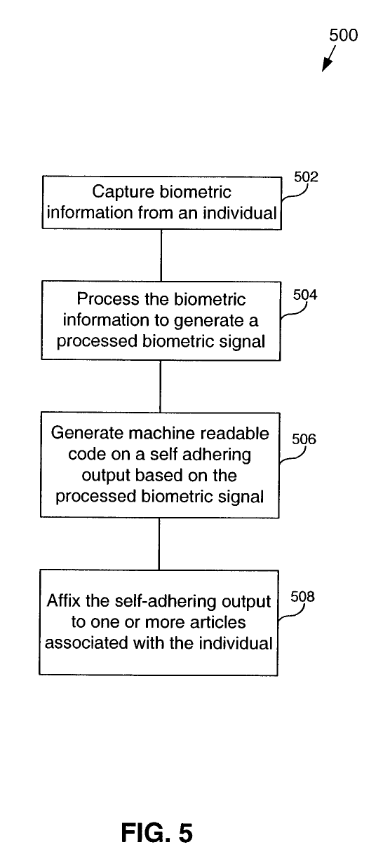

FIG. 5 shows a flow chart of a method 500 for generating an output that includes a machine readable code representation of biometric information according to embodiments of the present invention. At step 502, biometric information is captured from an individual. For example, it is captured by capture device 102. At step 504, the biometric information is processed to generate a processed biometric signal. For example, it is processed by processor 104. As described above, in the case of live fingerprint capture, the processed biometric signal can include print image data and/or extracted minutia information. At step 506, machine readable code is generated on a self adhering output based on the processed biometric signal, the machine readable code being representative of the captured biometric information. For example, the self adhering output is generated by output device 106, and is output 108. For example the machine-readable code is machine-readable code 200, which may be any of the codes described herein, or otherwise known. At step 508, the self-adhering output is affixed to one or more articles associated with the individual.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the abovedescribed exemplary embodiments, but should be defined only in accordance with the following claims and their equivalents.

What is claimed is:

1. A system comprising:
a biometric capture device that captures biometric information of an individual checking in at a facility;
a processor that processes the biometric information captured by said biometric capture device to generate a processed biometric signal; and
an output device that receives the processed biometric signal from said processor and that generates a self adhering output based on the signal, the output including a machine readable code representation of the processed biometric information and the output being associated with an object of the individual.

2. The system of claim 1, wherein said machine-readable code is an encrypted representation of the processed biometric information.

3. The system of claim 1, wherein said machine-readable code is a barcode representation of the processed biometric information.

4. The system of claim 1, wherein said machine-readable code is a digitally signed representation of the processed biometric information.

5. The system of claim 1, wherein said machine-readable code is an encoded representation of the processed biometric information.

6. The system of claim 1, wherein said machine-readable code is a two dimensional barcode representation of the processed biometric information.

7. The system of claim 1, wherein said machine-readable code is a three dimensional barcode representation of the processed biometric information.

8. The system of claim 1, wherein said self adhering output is a label with an adhesive section.

9. The system of claim 1, wherein said self adhering output is a tag with an adhesive section.

10. The system of claim 1, wherein said object is a pass.

11. The system of claim 1, wherein said object is a ticket.

12. The system of claim 1, wherein said object is a voucher.

13. The system of claim 1, wherein said object is a badge.

14. The system of claim 1, wherein said object is a bag.

15. The system of claim 1, wherein said biometric information is fingerprint information.

16. The system of claim 1, wherein said processed biometric signal is based on extracting biometric data from the biometric information.

17. A method comprising the steps of:
capturing biometric information from an individual;
processing the biometric information to generate a processed biometric signal; and
generating machine readable code on a self adhering output based on the processed biometric signal, the machine readable code being representative of the captured biometric information.

18. The method of claim 17, wherein said generating step generates an encoded machine-readable code as the machine-readable code.

19. The method of claim 17, wherein said generating step generates encrypted machine-readable code as the machine-readable code.

20. The method of claim 17, wherein said generating step generates digitally signed machine-readable code as the machine-readable code.

21. The method of claim 17, wherein said generating step generates a two dimensional barcode as the machine-readable code.

22. The method of claim 17, wherein said generating step generates a three dimensional barcode as the machine-readable code.

23. The method of claim 17, wherein said processed biometric signal is based on extracting biometric data from the biometric information.
